(19) United States
(12) Patent Application Publication
(10) Pub. No.: US 2005/0108232 A1
(43) Pub. Date: May 19, 2005

(54) Electronic submittal method and system

(75) Inventor: Brian Matthew Rockey, Olathe, KS (US)

Correspondence Address: HUSCH & EPPENBERGER, LLC, 190 CARONDELET PLAZA, SUITE 600, ST. LOUIS, MO, 63105-3441, US

(73) Assignee: The Rockey Group, Inc., Shawnee, KS (US)

(21) Appl. No.: 10/992,875

(22) Filed: Nov. 18, 2004

Related U.S. Application Data
(60) Provisional application No. 60/523,484, filed on Nov. 19, 2003.

(51) Int. Cl. G06F 7/00

(52) U.S. Cl. 707/8

(57) ABSTRACT

A method and system of managing a submittal approval process includes the steps of granting access to an internet-based system to a set of users; permitting a first user to upload a submittal to the system; recording the uploading of the submittal in a log accessible by the users; automatically issuing a notice of the uploading of the submittal to other users; providing access to the submittal to other users and permitting the other users to review, approve, reject, revise, or comment on the submittal; recording the actions of the other users in the log; automatically issuing a notice of a user's actions to other users on the system; and generating a report of the log at the request of a user.

### CROSS-REFERENCE TO RELATED APPLICATIONS

This application claims the priority of provisional application Ser. No. 60/523,484, filed Nov. 19, 2003.

### TECHNICAL FIELD OF THE INVENTION

The present invention relates generally to a document sharing system, and more particularly to an online, membership-based system designed for the post bid submittal approval process used in construction projects.

### BACKGROUND OF THE INVENTION

The submittal approval process, as described in the drawings, details, and descriptions, is participated in by a variety of persons or organizations, is often different for each project, and may or may not include different parts of the standard approval chain. The following definitions are provided for clarity purposes, but are not intended to be inclusive of all possible combinations in the process:

Submittal—The term submittal will be used throughout the following drawings, details, and description to define documentation required for approval of any material, product, equipment, service, and/or method of construction. This documentation may or may not include information regarding size, location, material construction, weight, general description, specifications, method of application, and all other necessary details required to prove that the material, product equipment, service, and/or method of construction meets the design intent in the projects plans and specifications. The term submittal is also intended to include any documentation requiring an approval process and includes, but is not limited to as-built drawings, operation and maintenance manuals, warranty information, applications of all types, reports of all types, and any additional documentation where any approval action is required.

Submittal Creator—This is the person or organization that is responsible for creating the submittal for approval regarding a product, material, equipment, or method of construction. This person or organization may be a vendor, distributor, manufacture representative, factory, sub-contractor, and/or general contractor. The term submittal creator will be used throughout this document to define a person or organization that receives a request to provide submittals for approval, prepares the submittals, copies the documentation (8-16 times), and/or forwards for review and approval.

First Reviewer—This is the person or organization that places an order, or enters into a contract with the submittal creator and requests that person or organization prepares eight to sixteen (8-16) copies to send them for review and/or approval. The first reviewer will receive the submittals; review for accuracy, and forward to the next person or organization in the chain. The first reviewer may or may not make comments, field verify measurements or dimensions, and note any variances or details noted from the review. The first reviewer will then forward the submittal on to the next person or organization in the chain. Types of persons or organizations that are involved as the first reviewer can include, but are not limited to: manufacture representative, vendor, distributor, factory, sub-contractor, general contractor, prime contractor, construction manager, architect, engineer, and owners of any type. In certain projects, the first reviewer can be used synonymously with final approver.

Additional Reviewer—This person or organization is next in the chain after the first reviewer. This company will participate in a similar manner to the first reviewer in that they may or may not make comments, field verify measurements or dimensions, and note any variances or details from the review. The additional reviewer will then forward the submittal on to the next person or organization in the chain. The types of persons or organizations that may be additional reviewers also include but are not limited to: manufacture representative, vendor, distributor, factory, sub-contractor, general contractor, prime contractor, construction manager, architect, engineer, and owners of any type. There may be multiple additional reviewers on any given project depending on the material, product, service, or method of construction that the submittal contains, the structure of the construction and/or design review team, and owner participation. In certain projects, the additional reviewer can be used synonymously with final approver.

Final Approver—This term is used to describe the person or organization that will be the final authority for approving any particular submittal. This person or organization is the final participant in the chain of the submittal creator, first reviewer, and additional reviewer. This person or organization conducts the final review of the documentation provided in the submittal for accuracy and compliance with the design plans, specifications, and intent. The types of persons or organizations that may be final approver include but are not limited to: manufacturer representative, vendor, distributor, factory, sub-contractor, general contractor, prime contractor, construction manager, architect, engineer, and owners of any type.

Non-Approving Reviewer—This term will be used to describe a person or organization who receives a copy of a submittal but does not actively review or participate in the approval process. The types of person or organization that may be non-approving reviewer include but are not limited to: manufacturer representative, vendor, distributor, factory, sub-contractor, general contractor, prime contractor, construction manager, architect, inspector, engineer, and owners of any type. The non-approving reviewer may receive a copy of the submittal for a variety of reasons that include, but are not limited to: monitoring of submittal approval process, permanent record keeping, inspection purposes, and related work considerations.

Review—This term is used to describe action taken by the first reviewer, additional reviewer, or final approver. This action can include, but is not limited to, review, approve, approve with comments, accept, accept with comments, revise and resubmit, reject, make corrections noted, no action taken, and review for accuracy. Actions are specific to the project and the person or organization working on a given project. The current submittal approval process utilized by the industry is illustrated in the following description and in FIG. 1.

As a specific example of the current model of submittal approval, an architect is hired by an owner to construct a new office building. The architect will design the facility and will typically hire specialty engineers to design portions of the building. In this example, the architect will hire a mechanical engineer to design the HVAC (air conditioning) for the facility. Upon completion of the design, the architect will publish a set of drawings, also known as plans, and specifications. This information will provide all of the requirements for the construction of the building. General contractors will submit bids on a specific time and date for construction on the facility per the plans and specifications set forth by the architect. The architect and owner will evaluate the bids and award the project to the general contractor based on a variety of factors, including, but not limited to price, previous experience, speed of completion, and reputation.

Upon award of the contract, the general contractor will be required to furnish submittals on all sections required in the architect's specifications. The general contractor then will contract with a variety of sub-contractors for particular specialty work. In this example, a mechanical contractor will complete the HVAC component of the project. The general contractor will require that the sub-contractor furnish all required submittals. The mechanical sub-contractor will typically purchase specific mechanical HVAC equipment from a local area manufacturer representative. The sub-contractor will require that the manufacturer representative furnish a submittal.

The manufacturer representative will then prepare the submittal and copy the documentation between 8-16 times. For this example, we will select 12 copies. The 12 copies are then shipped from the manufacturer representative's office to the mechanical sub-contractor. The mechanical sub-contractor is often required by the architect's specifications to indicate that the submittal have been reviewed for accuracy. The mechanical sub-contractor then ships the submittal to the general contractor. The general contractor is then also required by the architect's specifications to review the submittal for accuracy. The general contractor will then ship the submittal to the architect. The architect will then review the submittal and forward to the mechanical engineer that was hired to design the HVAC system.

The mechanical engineer will review the submittal for acceptance under the design plans and specifications. The mechanical engineer will review and indicate any comments, corrections, revisions, or other indications necessary for the information submitted. The submittal is then shipped back to the architect, who ships it to the general contractor, who ships it to the mechanical sub-contractor, who ships it to the manufacturer representative. At this point, the manufacturer representative will either be able to order or release the particular piece of equipment the submittal pertained to, or make corrections required by the mechanical engineer (or others in the approval chain) and resubmit corrected a submittal. This process repeats until final approval by the mechanical engineer is received.

Systems currently available today include large project management suites attempting to provide solutions to all aspects of one particular persons or organizations needs. These solutions are typically directed at the general contractor (prime contractor, construction manager) and include all aspects of pre-design, design team selection, design activities, non-design activities, contractor selection and construction. The submittal process cross-cuts all members of the construction team, unlike budget tracking which may only affect the owner, general contractor or project manager, but would likely not affect the vendor or factory. For the factory, getting rapidly available information regarding the approval of the submitted product carries more value than detailed budget information for an unrelated sub-contractor. Because of the project management service's desire to service the needs of the general contractor, specific industry-wide opportunities exist to provide value to all players, such as in the submittal process.

Construction management suites have a submittal log feature which is substantially different from the invention detailed here. The submittal log allows persons or organizations participating in the approval process to enter dates when the paper copies of a submittal arrive and leave that person or organization's office. This does not accomplish the elimination of the need for shipping submittals, nor does it provide the real-time maintenance and distribution of the self-generated history described in the invention below.

An additional existing solution is that of an on-line plan room. This system consists of a central location that one type of organization will choose to post their plans and specifications, or any type of documentation they choose for review by other companies. This solution often requires a provided login and password. This type of a solution provides no method of establishing the required chain of approval nor does it attempt to provide real time information to the parties participating in that chain. Further, these suites provide only single user-specific logs rather than a complete submittal log of all users and participants in the submittal approval process.

Some prior art systems attempt to provide a structure, method, and process of program management in the field of building construction. For example, U.S. Patent Application Pub. No. 2003/0135401 A1 by Parr teaches the concept of using a computer system to monitor, track, and indicate progress through each of the phases, activities, processes, and tasks of a given construction project. Parr, however, does not attempt to provide a real-time discrimination process.

Other prior art systems attempt to arrange product elements in a hierarchical manner and store the elements in a database. For example, U.S. Patent Application Pub. No. 2001/0052908 A1 by Hartman teaches the concept of receiving a selection for a product element. A performance value associated with the selected product element is received and a text segment associated with each selected product element is retrieved. Hartman, however, does not attempt to provide a real-time discrimination process.

It would be advantageous to provide an electronic manifestation of the submittal approval process that eliminates significant dedication of resources by all members involved and allows for timely, real-time information sharing amongst various players in the submittal approval process.

The present invention is directed to overcoming one or more of the problems set forth above.

### SUMMARY OF THE INVENTION

An aspect of the present invention is to provide an electronic manifestation of the submittal approval process that eliminates significant dedication of resources by all members involved and allows for timely, real-time information sharing amongst various players in the submittal approval process.

Another aspect of the invention is to provide an electronic manifestation of the submittal approval process that allows the entire process, including any comments, comment files, action requests, document history and other useful support data about a given submittal, to be tracked electronically by uploading submittal documents to the system,

Yet another aspect of the invention is to provide an electronic manifestation of the submittal approval process that eliminates or greatly reduces the costs associated with shipping, copying, handling and printing and provides information to the relevant parties in the approval process in real time, thereby providing cost savings and improving information accessibility to the members of a construction team.

Another aspect of the invention is to provide an electronic manifestation of the submittal approval process that provides a complete submittal log of all users and participants in the submittal approval process as opposed to the single user-specific log provided by said suites.

In accordance with the above aspects of the invention, there is provided a method of managing an approval process for a submittal that includes the steps of granting access to an internet accessible system to a first set of users; permitting a first user of said first set of users to tender a first submittal to said internet accessible system; recording said tender of said first submittal in a log accessible by said first set of users via said internet accessible system; automatically issuing a notice of the tender of said first submittal to at least a second user of said first set of users via said internet accessible system; providing access to said first submittal to said second user of said first set of users via said internet accessible system and permitting said second user of said first set of users to perform a first action relating to said first submittal; recording said first action relating to said first submittal in said first log; automatically issuing a notice of said first action relating to said first submittal to at least one of said set of users once said first action relating to said first submittal is recorded in said first log; and generating a report of said first log at the request of at least one of said first set of users.

The system will allow specifically for the submittal creator to upload the submittal to the system and forwards notification of the submittal posting to the first reviewer. The first reviewer will be able to review the submittal, indicate corrections and/or comments, mark the submittal as reviewed. The system then forwards notification to any additional reviewer as necessary. A unique history will be created as the submittal is passed through the approval process from submittal creator, through the first reviewer, additional reviewers, and to the final approver. Comments will be tracked in each person or organization's unique history box to determine exactly which person or organization has made comments, modifications, or revisions. Every file (original submittal or comment) will be preserved as originally uploaded to the system. Persons or organizations will have access to the original files, but any modifications or changes will be shown as a new file directly associated with that person or organization's history. Email notifications are automatically generated through the unique history to keep every person or organization who has participated in the particular submittal's approval process informed in real time of the actions of the persons or organizations downstream in the approval chain. Upon the final approver's approval action, every person or organization that is a part of the submittal's self-generated history will be notified of the action via email.

These aspects are merely illustrative aspects of the innumerable aspects associated with the present invention and should not be deemed as limiting in any manner. These and other aspects, features, and advantages of the present invention will become apparent from the following detailed description when taken in conjunction with the referenced drawings.

### BRIEF DESCRIPTION OF THE DRAWINGS

Reference is now made to the drawings which illustrate the best known mode of carrying out the invention and wherein the same reference numerals indicate the same or similar parts throughout the several views.

FIG. 1 is a flow chart of a prior art submittal approval process.

FIG. 2 is a process flow diagram of an electronic submittal system according to one embodiment of the present invention.

FIGS. 3-14 are screen shots of a web-based submittal system according to an embodiment of the present invention.

FIG. 15 is a flow diagram of an electronic submittal system according to an embodiment of the present invention

FIG. 16 is a chart illustrating the timing for use of the screens illustrated in FIGS. 3-14.

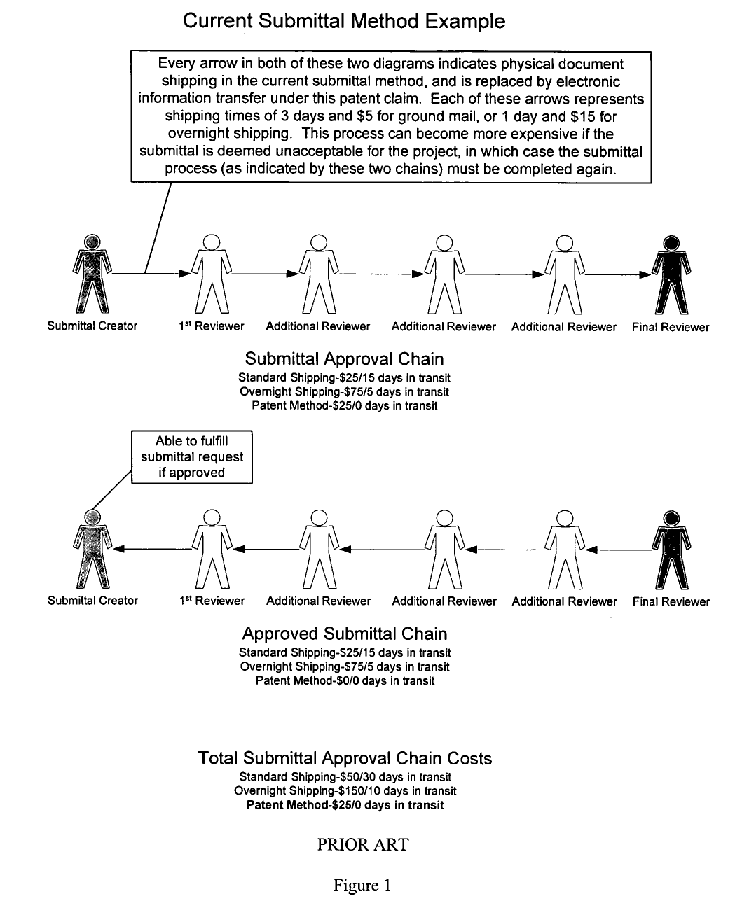

### DETAILED DESCRIPTION OF THE PREFERRED EMBODIMENTS

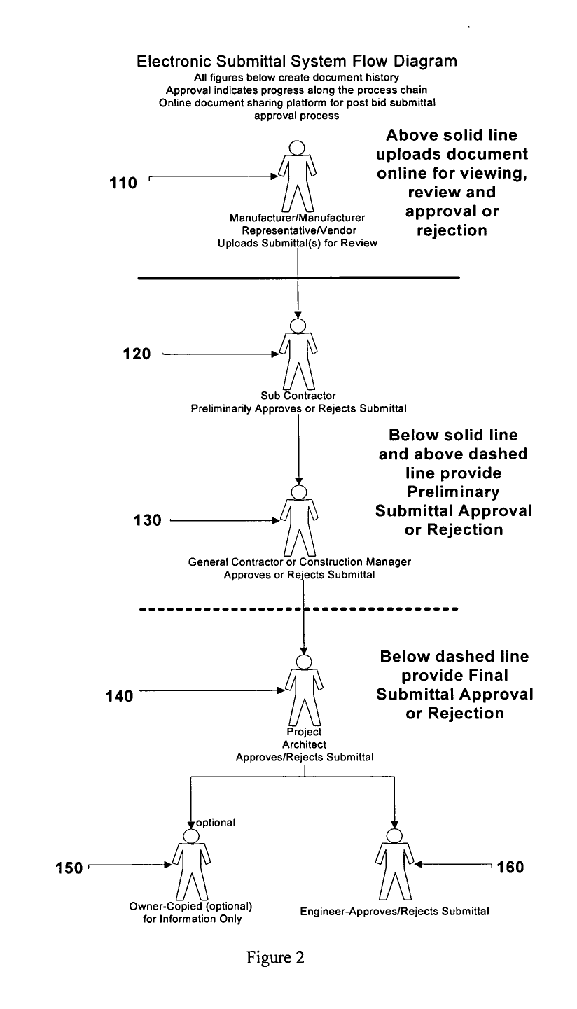

FIG. 2 illustrates a process flow diagram according to the present invention. The electronic submittal system is generally indicated as reference character 100. The electronic submittals system 100 will also work the same for every major piece of equipment that a submittal is required for. A manufacturer representative or vendor will receive an order from a subcontractor, general contractor, architect, or owner. The manufacturer representative or vendor will then complete the submittal and scan the document onto their computer, if the submittal is not already in an electronic format. The manufacturer representative or vendor will login to the website and upload the document into a website (such as www.easysubmittals.com). The manufacturer representative or vendor will fill out the project title, the type of equipment being submitted, and select the person or parties to whom any notification should be sent. The subcontractor will receive an email indicating that the submittals from the manufacturer representative are available for review at the web site. The e-mail can include the project title and the type of equipment or other reference information.

The subcontractor will login to the website and be able to see the document is available. The subcontractor will be able to print the document if desired, and can group different submittals into a created folder. The left hand column next to the document will allow him to add comments if required and enter the person or parties to whom he would like to forward the email notification. The process will continue through the general contractor, architect, and engineer. The engineer will make appropriate comments in the comments field and indicate whether the plans are approved, rejected, revised or are indicted by any other status event 150.

Each company is notified by email each time a submittal history is affected by any member in the chain approving, commenting, editing, or forwarding the document. This allows for real-time updates of the submittal process to each company in the particular chain.

Another benefit of the system 100 is that the website will allow customers to pay a yearly membership fee to use the system for as many different projects as needed. Competitive systems charge project owners per each project as a separate item.

Another benefit of the system 100 is that the website will allow for simultaneous updates to every member in the submittals process for the history of the document. This will allow every company to see exactly what the current status of each document is and what changes or comments have been made. Customers will receive an email and not have to log into the system to be made aware that an action has updated their particular document.

Yet another benefit of the system 100 is that the website will create a complete document history including comments, editing of documents, approval action, and transmitting on to other companies. This comprehensive sheet of document history will be saved to a computer or printed to show proof of approval and actions by all companies in the process.

Another benefit of the system 100 is that the website will allow for each customer to make a unique folder system organization of their own files and will not be affected by how other companies prefer to organize their files.

Yet another benefit of the system 100 is that the website will allow for non-customers to be included in the chain by allowing them to log-in and view, print, and or download the document that has been sent from a current customer. This will allow for process continuity of whether or not every member of the chain is a customer.

Another benefit of the system 100 is that the website will allow for each customer upon creation of account to load a custom approval signature. This will protect each member in the chain as their physical stamp does in the traditional manner. The signature will be loaded into the customer profile and be attached to each action item when completed by the specific customer. The signature will typically include legal terminology as to the conditions or each company that they accept with their approval action.

Another benefit of the system 100 is that the service will allow for any submittal file to be downloaded to a location specified by the user. This will allow for the customer to create an electronic storage location via hard drive, CD, or DVD to eliminate costly storage cost associated with the traditional paper method.

Another benefit of the system 100 is that the system will allow for comments and edited submittals to be saved as separate items in the history for the particular company that has done the commenting or editing. The initial document will remain intact as originally submitted with each company history showing the associated comments or edited documents.

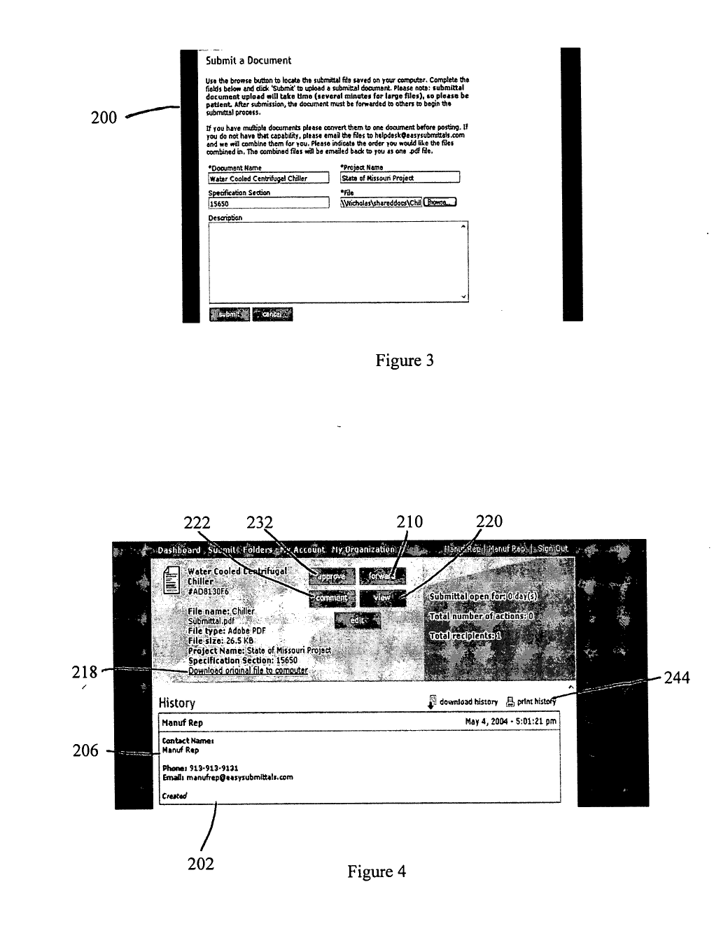

Although the present invention is not limited by the format of the web site, a proposed format is now presented to help describe the invention. The described embodiment of the system allows each participating member will be allowed to set-up and create a unique account and log-in using the members email address and self selected password. The submittal creator will login to the website and upload the submittal onto the system. The submittal creator will fill out the project title, the submittal name, along with any additional pertinent information including, but not limited to, specification section, project number or code, and any general description appropriate. The submittal creator will locate the electronic file for the submittal on his or her computer and upload the file to the system. A unique history is then automatically created for that particular submittal showing all of the information entered by the submittal creator as well as the submittal creator's account information including email address, phone number, job title, and name. The exact time and date will be shown in the unique history for verification. FIG. 3 illustrates a submittal upload screen 200 in the preferred embodiment.

FIG. 4 illustrates the unique submittal history 202 created based on the information entered by the submittal creator at the submittal upload screen 200 shown in the upper left-hand corner. A chronological history is automatically generated for each unique submittal, as shown in the lower half of FIG. 4. The submittal creator's account information 206 is also shown along with specific time, date, and appropriate action recorded.

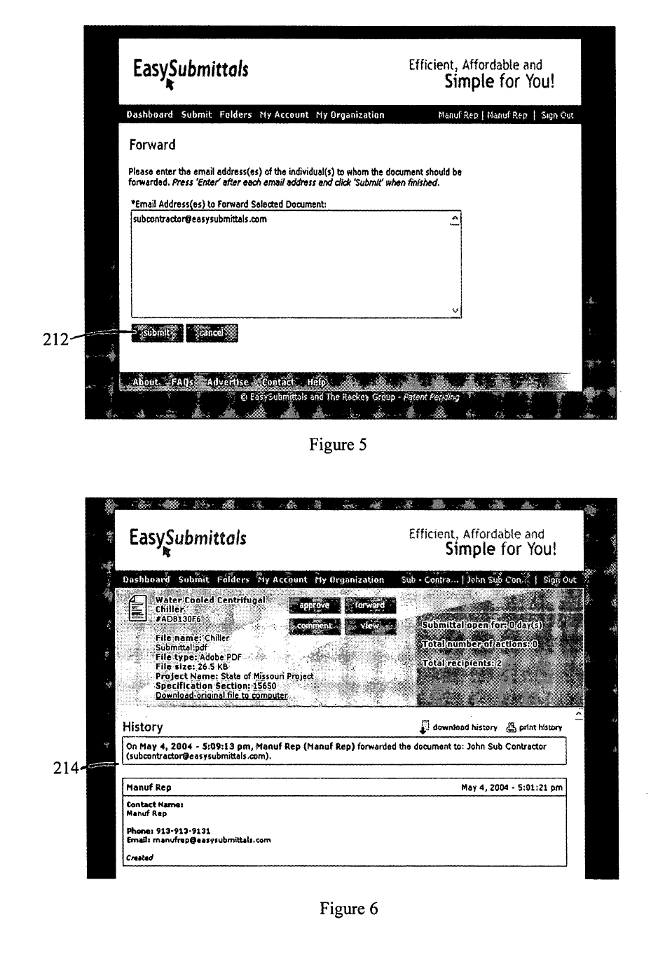

Once the submittal creator has uploaded the submittal the process of moving the submittal through the approval chain is started by forwarding the document to the first reviewer. In the screen in FIG. 4, the submittal is forwarded to the first reviewer by clicking on the large green forward button 210 located at the top center of the screen. As illustrated in FIG. 5, the system then requests that the submittal creator enter the email address of the first reviewer and initiate the forwarding process by clicking on the “Submit” button 212 located at the bottom-left corner of the screen. The system automatically enters the action of forwarding the submittal to the first reviewer in the submittal history, as illustrated in FIG. 6. Each time a submittal is forwarded, such action is automatically recorded, including chronological information, in the submittal history 214.

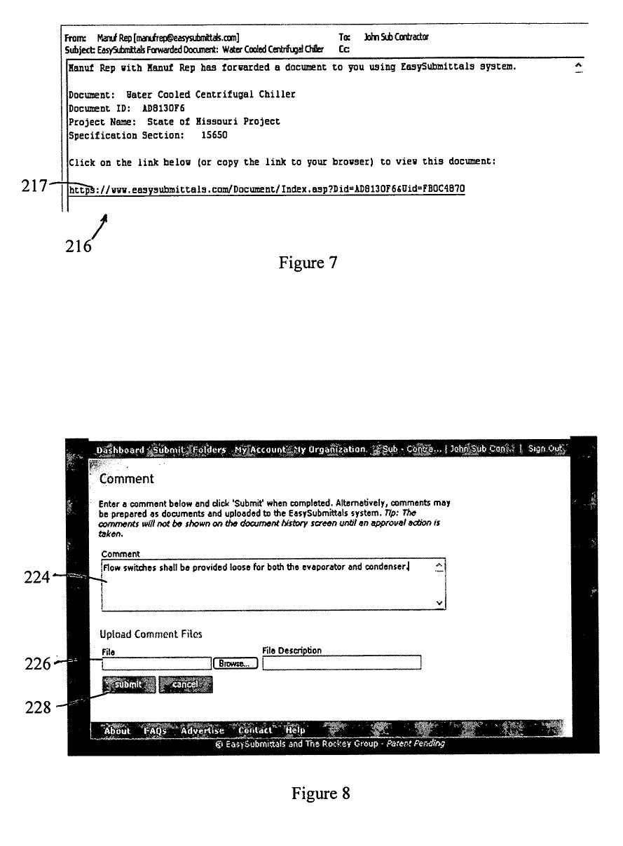

In the embodiment shown, the system does not email the submittal to the first reviewer upon completion of this task. Instead, the system generates an automatic email 216 from the submittal creator to the first reviewer indicating that a submittal has been forwarded for their review on the system. That email will also provide the identifying information that the submittal creator entered when uploading the submittal onto the system initially. The email also contains a link 217 that will take the first reviewer directly to the unique submittal history shown in FIG. 4. FIG. 7 provides an illustration of an exemplary forwarding email 216.

The unique history for each submittal will be shown in the same format and with the same content to all system users with access to that submittal. Any time a system user adds to the unique submittal history, that history is automatically updated for all users who have access to the submittal.

Upon receipt of a forwarding email, the first reviewer is able to review the submittal via two different methods. A feature of the preferred embodiment is that any submittal uploaded to the system is automatically converted to a .pdf (“portable document file”) format. The original file format uploaded to the system is also kept and any user may choose to work with either the original file format, or the .pdf version of the original file format. Any system user can access the original file format by clicking on a “Download Original File to Computer” link 218 provided beneath the submittal information in the upper left hand corner of screen illustrated in FIG. 4. The .pdf version is accessed by clicking on the large green “View” button 220 located in the top center portion of the screen. This functionality provides a common bridge between the different types of software applications that may or may not be found on each user's computer. The file conversion process is automatic and requires no effort or action from any user of the system.

Once the first reviewer has accessed the system and reviewed the submittal, they may choose to make comments to be recorded in their organizations history as tracked at the bottom of the screen shown in FIG. 4. The system allows for comments to be made in two different manners. The user will click on the large green “Comment” button 222 shown at the top center of FIG. 4. This will take the user to the screen shown in FIG. 8. The first reviewer will be able to type text comments shown in the “Comment” box 224 shown in the center of the screen. The first reviewer will also be able to upload any file deemed appropriate to that user in the “Upload Comment Files” section 226. Comment files may include, but are not limited to: the original submittal edited either electronically or manually, any field verification of measurements, and any additional information of any kind. The comments made by the first reviewer are saved on the system when the green “Submit” button 228 is clicked on, but the comments will not be shown, or added to the unique history, until an approval action is taken. This provides each user the flexibility to save comments in progress without sharing this information with the rest of the participating users on this submittal until that user is prepared to do so. The system will automatically convert any uploaded comment files to a .pdf format and give any additional user the choice of viewing the original uploaded comment file or the .pdf version similar to the method described for the original submittal. The comments and/or comment file uploaded will be shown following an approval action inside that user's unique history action box 230, an example of which shown in FIG. 10. This feature provides all users with discrete information in regards to exactly which user made what comment, modification, etc. This information provides a detailed and verifiable history and provides precise information to all users participating on each unique submittal. Upon clicking on the green “Submit” button the user will be taken back to the unique submittal history screen, FIG. 4.

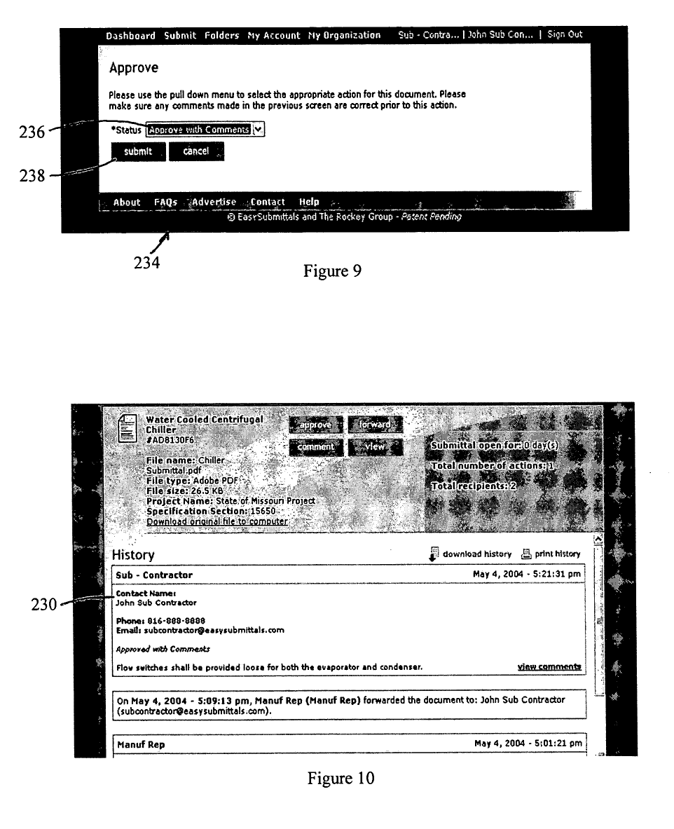

The first reviewer can take an approval action by clicking on the large green “Approve” button 232 again at the top center of the screen shown in FIG. 4. This will take the user to an approval screen 234 as illustrated in FIG. 9. A drop down menu 236 on this screen includes a number of options, including, but not limited to, approved, accepted, revise and resubmit, reviewed, rejected, etc., that the first reviewer can select. If the first reviewer has previously made comments, the system will automatically recognize that previous comments have been made and will change the options available to the user to include the phrase “with comments” on the various review options. The first reviewer will select the appropriate approval action and click on the green “Submit” button 238. This approval action will be automatically recorded in the unique submittal history 230, as illustrated in FIG. 10.

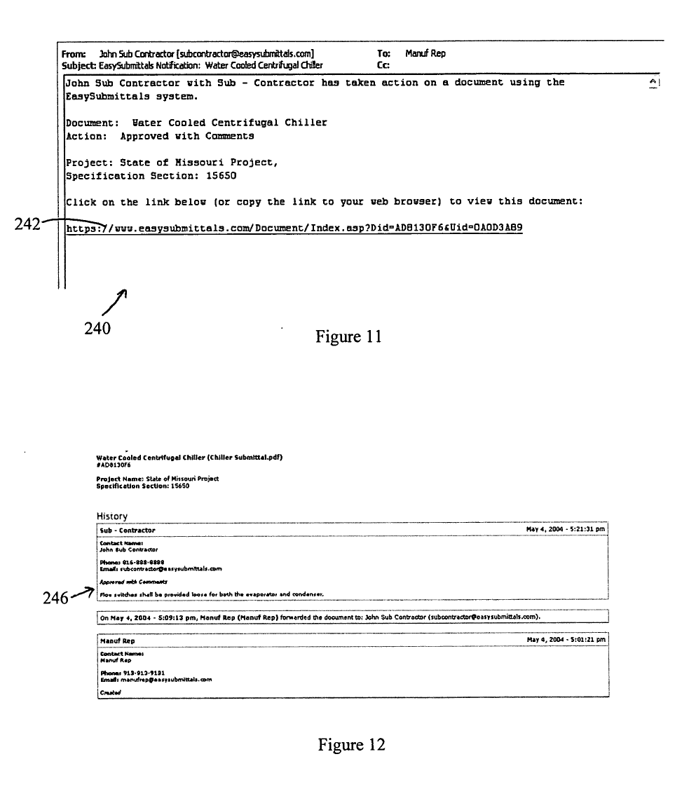

The first reviewer may now forward notice of the approval action to any additional or final reviewers. The system will automatically notify via email all previous participating users in the submittal history that the document has been forwarded from the first reviewer to the additional or final reviewer. The system will chronologically track the approval and forward actions taken along with comments and comment files tracked specifically within each unique user's history section. An example of an automatically generated email 240 showing that an approval action has been taken is illustrated in FIG. 11. This is another example of one of the major benefits and unique features of the system. The system will generate an automatic email which notifies the submittal creator, first reviewer, and all additional reviewers that a change has occurred to the submittal history. The email will indicate the identifying information provided by the submittal creator and again provide a link 242 that will direct any recipients to the newly updated submittal history. The email also indicates the approval action taken by the first reviewer and will help to determine if the submittal creator needs to take any additional action for this particular submittal. The system will continue to function in the same manner for any number of additional reviewers or any type of participants for a given submittal. The system allows for everyone involved in the submittal process to receive detailed real-time information.

The submittal approval process is typically completed when the final approver takes an approval action. Every previous user of the system that is accounted for in the unique submittal history is notified of this action. The system now allows for any user to print, view, or save a complete unique history for that submittal through a “Print History” link 244 shown on the right hand side in the center of the page illustrated in FIG. 4. The “Print History” link will automatically generate a stand-alone version of that submittal history 246, an example of which is illustrated in FIG. 12.

The system will allow for each user to make a unique folder-based organization of their own files that will not be affected by how other persons or organizations using the system prefer to organize their files. The forwarding function will be available to any user through the folders section allowing the user the flexibility to forward multiple submittals simultaneously from one folder location.

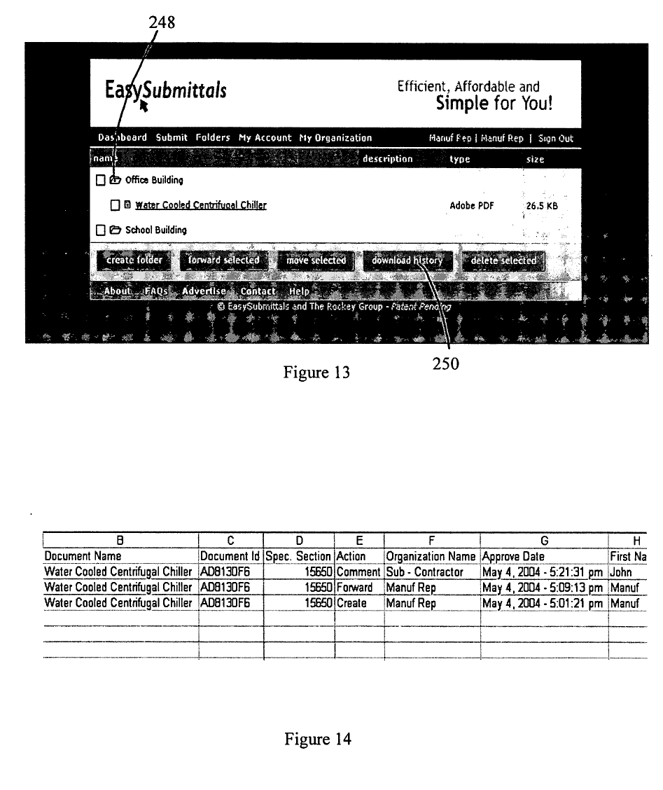

The system will generate a submittal log. This unique feature will display all of the information shown in the history section in a comma-delimited format that will upload into spreadsheet software. This provides any user a complete history of their submittal log as well as the submittal log of all other participants for each unique submittal. To generate a submittal log, a user of any type may select a folder 248 of a submittal and click on the blue “Download History” button 250 shown at the bottom of the screen illustrated in FIG. 13. The “Download History” action will show either specific files selected prior to clicking the button, or the entire selection of submittals inside a selected folder, or any combination of the two. A sample screen illustrating this output is illustrated in FIG. 14.

Non-customers can also be included in the approval chain by allowing them to log-in and view, print, and/or download the document that has been sent from a current customer. This will allow for process continuity regardless of whether or not every member of the chain is a customer. This process is specifically designed for non-approving reviewers who would like access to the submittal for a variety of reasons listed in the non-approving reviewer definition.

The system also allows each customer to load a custom approval signature upon creation of an account. This will protect each member in the chain in the same manner as a physical stamp does in the traditional approval process. The signature is loaded into the customer profile and is attached to each action item when completed by the specific customer. The signature will typically include legal terminology as to the conditions of each person or organization that they accept with their approval action.

The system also permits users to download any submittal file to a location specified by the user. This will allow for the customer to create an electronic storage location via hard drive, CD, or DVD to eliminate costly storage cost associated with the traditional paper method.

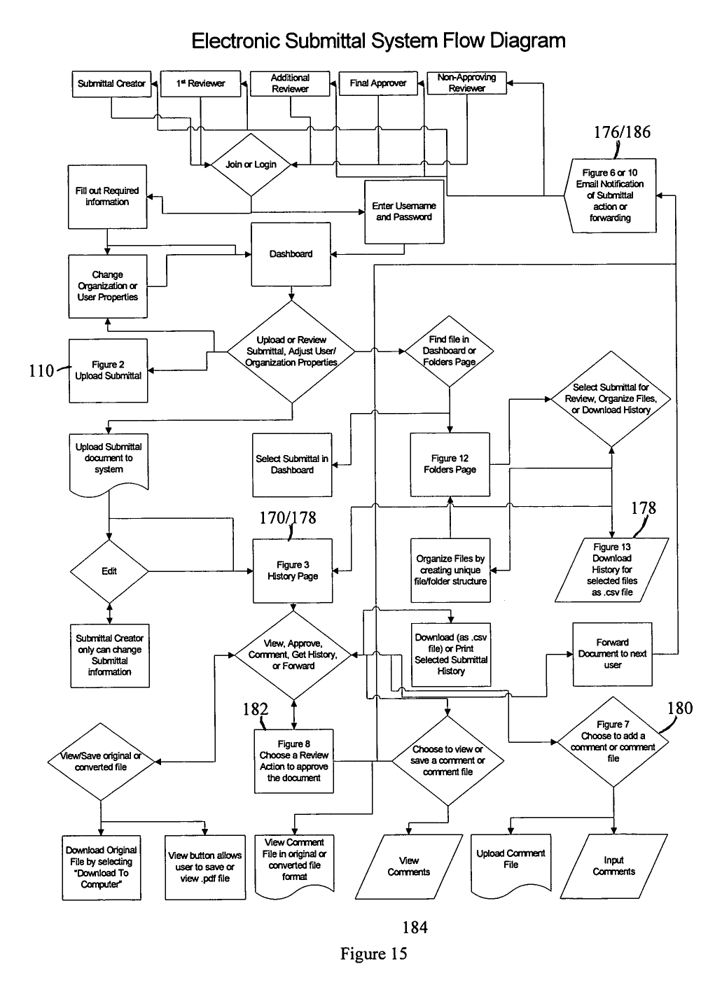

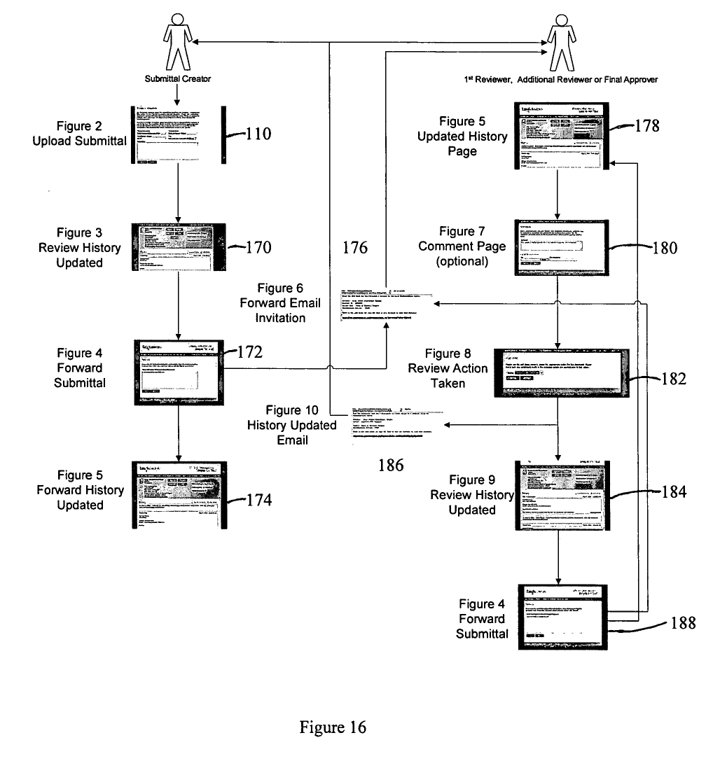

The above described embodiment of the system and interrelation of the screen examples discussed and illustrated in FIGS. 3-14 are further explained by the flow charts FIGS. 15 and 16.

FIG. 16 is a basic flow chart of the system process. The submittal creator uploads the submittal 110. The submittal creator may then review the updated submittal history 170 and forward the submittal 172 to the first reviewer. The system then simultaneously updates the forwarding history 174 for the submittal and forwards an email 176 to other users on the system, including the first reviewer. The first reviewer may then review the updated submittal history 178 and make comments 180. The reviewer may then enter a review action 182, at which time the system updates the review history 184 and forwards an email reflecting the updated history 186 to the other system users. The reviewer may then forward the submittal 188 to another reviewer or to the submittal creator, whereupon the system creates and forwards an email to the next reviewer or submittal creator.

FIG. 15 shows the basic process of the system, but also illustrates the decision points that user have in using the system.

While the non-limiting example of an electronic submittal system provided herein refers generally to a construction contracting process, those of skill in the art will recognize that the described method is equally applicable to any setting in which a bids or design or product submittals are reviewed, revised and approved, or other collaborative efforts, for example, service industries, such as computer programming.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention is not limited by the above-described exemplary embodiments, but is defined only in accordance with the following claims appended hereto and their equivalents.

1. A method of managing an approval process for a submittal, comprising the steps of:
granting access to a network accessible system to a first set of users;
permitting a first user of said first set of users to tender a first submittal to said network accessible system;
recording said tender of said first submittal in a first log accessible by said first set of users via said network accessible system;
automatically issuing a notice of the tender of said first submittal to at least a second user of said first set of users via said network accessible system;
providing access to said first submittal to said second user of said first set of users via said network accessible system and permitting said second user of said first set of users to perform a first action relating to said first submittal;
recording said first action relating to said first submittal in said first log;
automatically issuing a notice of said first action relating to said first submittal to at least one of said first set of users once said first action relating to said first submittal is recorded in said first log; and
generating a report of said first log at the request of at least one of said first set of users.

2. The method of managing an approval process for a submittal as set forth in claim 1, wherein said first action relating to said first submittal is selected from the group consisting of:
approving said first submittal;
rejecting said first submittal;
revising said first submittal; and
commenting on said first submittal.

3. The method of managing an approval process for a submittal as set forth in claim 1, further comprising the steps of:
providing access to said first submittal and to said first action relating to said submittal to a third user of said first set of users and permitting said third user to perform a second action relating to said first submittal;
recording said second action relating to said first submittal in said first log; and
automatically issuing a notice of said second action relating to said first submittal to at least one of said set of users once said second action relating to said first submittal is recorded in said first log.

4. The method of managing an approval process for a submittal as set forth in claim 3, wherein said second action relating to said first submittal is selected from the group consisting of:
approving said first submittal;
approving said first submittal as modified by said first action relating to said first submittal;
rejecting said first submittal;
rejecting said first submittal as modified by said first action relating to said first submittal; and
revising said first submittal.

5. The method of managing an approval process of a submittal as set forth in claim 1, wherein the step of automatically issuing a notice of the tender of said first submittal comprises creating and sending a first electronic mail message to said second user of said first set of users.

6. The method of managing an approval process of a submittal as set forth in claim 5, wherein the step of creating and sending a first electronic mail message comprises providing said second user of said first set of users with a network link to said first log.

7. The method of managing an approval process of a submittal as set forth in claim 1, wherein the step of automatically issuing a notice of said first action relating to said first submittal comprises creating and sending a second electronic mail message to at least one of said first set of users.

8. The method of managing an approval process of a submittal as set forth in claim 7, wherein the step of creating and sending a second electronic mail message comprises providing said at least one of said first set of users with a description of said first action relating to said first submittal and a network link to said first log.

9. The method of managing an approval process of a submittal as set forth in claim 1, wherein the step of recording said tender of said first submittal in said first log comprises recording an identity of said first user of said first set of users and a set of chronological information associated with said tender of said first submittal in said first log.

10. The method of managing an approval process of a submittal as set forth in claim 1, wherein the step of recording said first action relating to said first submittal in said first log comprises recording an identity of said second user of said first set of users and a set of chronological information associated with said first action relating to said first submittal in said first log.

11. The method of managing an approval process of a submittal as set forth in claim 3, wherein the step of recording said second action relating to said first submittal in said first log comprises recording an identity of said third user of said first set of users and a set of chronological information associated with said second action relating to said first submittal in said first log.

12. The method of managing an approval process of a submittal as set forth in claim 3, wherein the step of generating a report of said first log comprises allowing said one of said first set of users to select from among a set of filters consisting of:
reporting actions taken by said one of said first set of users; and
reporting all actions taken with respect to said first submittal.

13. The method of managing an approval process of a submittal as set forth in claim 1, further comprising the step of assigning an electronic verification to each of said first set of users.

14. The method of managing an approval process of a submittal as set forth in claim 1, further comprising the step of permitting one of said first set of users to select a document from the group consisting of said first submittal and said first action relating to said first submittal and to download said document from said network accessible system to an electronic storage device.

15. The method of managing an approval process of a submittal as set forth in claim 1, further comprising the steps of:
granting access to said network accessible system to a second set of users, including a common user belonging to said first and second sets of users;
permitting a first user of said second set of users to tender a second submittal to said network accessible system;
recording said tender of said second submittal in a second log accessible by said second set of users via said network accessible system;
automatically issuing a notice of the tender of said second submittal to at least a second user of said second set of users via said network accessible system;
providing access to said second submittal to said second user of said second set of users via said network accessible system and permitting said second user of said second set of users to perform a first action relating to said second submittal
recording said first set of changes to and comments regarding said second submittal in said second log;
automatically issuing a notice of said first action relating to said second submittal to at least one of said second set of users; and
generating a report of said second log at the request of at least one of said set of second users;

16. The method of managing an approval process for a submittal as set forth in claim 15, further comprising the step of limiting access of said first set of users to said first submittal and said first action relating to said first submittal and limiting access of said second set of users to said second submittal and said first action relating to said second submittal.

17. The method of managing an approval process for a submittal as set forth in claim 15, wherein said first action relating to said second submittal is selected from the group consisting of:
approving said second submittal;
rejecting said second submittal;
revising said second submittal; and
commenting on said second submittal.

18. The method of managing an approval process of a submittal as set forth in claim 15, further comprising generating a report for said common user, wherein said common user selects from among a set of filters consisting of:
reporting actions in said first log taken by said common user;
reporting actions in said first log taken by all of set first set of users;
reporting actions in said second log taken by said common user;
reporting actions in said second log taken by all of set second set of users;
reporting actions in said first and second logs taken by said common user; and
reporting actions in said first and second logs taken by all of set first and second sets of users.

19. The method of managing an approval process of a submittal as set forth in claim 1, further comprising the step of permitting said first user of said first set of users to select one from the group consisting of recording said first action relating to said first submittal to said first log and recording said first action relating to said first submittal to a separate file accessible only by said first user of said first set of users.

20. The method of managing an approval process of a submittal as set forth in claim 1, wherein the step of providing access to said first submittal to said second user of said first set of users further comprises permitting said second user of said first set of users to select one from the group consisting of said first submittal in text-editable format and said first submittal in portable document file format.

21. An electronic system for managing an approval process of a submittal, comprising:
means for granting access to a network accessible system to a first set of users;
means for permitting a first user of said first set of users to tender a first submittal to said network accessible system;
means for recording said tender of said first submittal in a log accessible by said first set of users via said network accessible system;
means for automatically issuing a notice of the tender of said first submittal to at least a second user of said first set of users via said network accessible system;
means for providing access to said first submittal to said second user of said first set of users via said network accessible system and permitting said second user of said first set of users to perform a first action relating to said first submittal;
means for recording said first action relating to said first submittal in said first log;
means for automatically issuing a notice of said first action relating to said first submittal to at least one of said set of users once said first action relating to said first submittal is recorded in said first log; and
means for generating a report of said first log at the request of at least one of said first set of users.

22. The electronic system for managing an approval process of a submittal as set forth in claim 20, further comprising the steps of:
means for providing access to said first submittal and to said first action relating to said submittal to a third user of said first set of users and permitting said third user to perform a second action relating to said first submittal;
means recording said second action relating to said first submittal in said first log; and
means for automatically issuing a notice of said second action relating to said first submittal to at least one of said set of users once said second action relating to said first submittal is recorded in said first log.

23. The electronic system for managing an approval process of a submittal as set forth in claim 20, further comprising means for assigning an electronic verification to each of said first set of users.

24. The electronic system for managing an approval process of a submittal as set forth in claim 20, further comprising means for permitting one of said first set of users to select a document from the group consisting of said first submittal and said first action relating to said first submittal and to download said document from said network accessible system to an electronic storage device.

25. The electronic system for managing an approval process of a submittal as set forth in claim 20, further comprising:
means for granting access to said network accessible system to a second set of users, including a common user belonging to said first and second sets of users;
means for permitting a first user of said second set of users to tender a second submittal to said network accessible system;
means for recording said tender of said second submittal in a second log accessible by said second set of users via said network accessible system;
means for automatically issuing a notice of the tender of said second submittal to at least a second user of said second set of users via said network accessible system;
means for providing access to said second submittal to said second user of said second set of users via said network accessible system and permitting said second user of said second set of users to perform a first action relating to said second submittal
means for recording said first set of changes to and comments regarding said second submittal in said second log;
means for automatically issuing a notice of said first action relating to said second submittal to at least one of said second set of users; and
means for generating a report of said second log at the request of at least one of said set of second users;

26. The electronic system for managing an approval process of a submittal as set forth in claim 20, further comprising means permitting said first user of said first set of users to select one from the group consisting of recording said first action relating to said first submittal to said first log and recording said first action relating to said first submittal to a separate file accessible only by said first user of said first set of users.

27. An electronic system for managing an approval process of a submittal, comprising:
a server in communication with a network and having a central processor and a memory;
a listserv stored in said memory; said listserv containing electronic mail addresses for a set of users;
a log stored in said memory, said log being automatically updated when a first user uploads a submittal to said memory and when a second user performs an action on said submittal; and
a network communication protocol device in said server and communicating with said central processor and said memory, said network communication protocol device automatically accessing said listserv and generating an electronic mail to each of said set of users when said log is updated.

28. The electronic system for managing an approval process of a submittal as set forth in claim 26, wherein said server is in communication with the internet.
